(19) United States
(12) Patent Application Publication
(10) Pub. No.: US 2011/0061355 A1
(43) Pub. Date: Mar. 17, 2011

(54) GRASS MOWING MACHINE WITH ENGINE SPEED AND VOLTAGE LIMITER

(76) Inventor: Randall J. Griffin, Erwin, NC (US)

(21) Appl. No.: 12/560,663

(22) Filed: Sep. 16, 2009

(51) Int. Cl. A01D 34/00

(52) U.S. Cl. 56/16.7

(57) ABSTRACT

A grass mowing machine with an electric reel drive motor mounted to a cutting reel and connected to an electrical bus. An internal combustion engine drives an alternator to produce a voltage on the electrical bus. An engine speed and voltage limiter monitors the voltage on the electrical bus and, if the voltage exceeds a specified threshold, closes a kill switch to interrupt the ignition function of the engine driving the alternator.

### FIELD OF THE INVENTION

This invention relates generally to grass mowing equipment, and more specifically to a grass mowing machine with an engine speed and voltage limiter for an engine driven alternator or generator supplying power directly to one or more electric reel drive motors.

### BACKGROUND OF THE INVENTION

Grass mowing machines such as walk behind greens mowers may include one or more cutting reels driven by electric motors. An electric reel drive motors may be bidirectional and variable speed, meaning it can spin forward or reverse and at a range of rotational speeds. An electric reel drive motor may be powered directly by an engine driven alternator or generator system.

For example, the alternator or generator may be a 48-V, 180 amp alternator that is belt-driven by an internal combustion engine. The alternator or generator may supply power to an electrical bus for the cutting reel circuit. The bus voltage may be unregulated. Other circuits, including starter, safety interlocks, lights, and accessory circuits, may be separately powered by a 12-V battery.

An electric reel drive motor on a grass mowing machine may have a motor controller that regulates power to the motor. The controller may maintain a consistent reel rotational speed across a wide throttle range, to maintain a desired cut quality, or may vary the speed in response to operator commands or other inputs.

Typically, internal combustion engines on grass mowing machines have governors that attempt to run the engine at specific speeds. However, engine speed may not be limited if the governor is overridden or abnormal fuel/air conditions are encountered. If that occurs, output voltage of the generator or alternator to the voltage bus may exceed the upper voltage limit of a motor controller.

There is a need for a grass mowing machine that limits the output voltage of an alternator or generator on a voltage bus for powering one or more electric reel drive motors. There is a need for a grass mowing machine that limits engine speed for an electric reel drive motor powered directly by an engine driven alternator or generator system. There is a need for a grass mowing machine that can prevent the output voltage of an alternator or generator on the voltage bus from exceeding the upper voltage limit of a motor controller for an electric reel drive motor.

### SUMMARY OF THE INVENTION

A grass mowing machine with a reel mower cutting unit having spiral cutting blades rotating on a horizontal axis in close proximity to a bedknife. An internal combustion engine with spark ignition is mounted to a frame supported by a traction drum coupled to the engine and rotating to move the machine forward during mowing. An electric reel drive motor is mounted to a side panel of the reel mower cutting unit and is powered directly by an engine driven alternator supplying power to an electrical bus to which the electric reel drive motor is connected. An engine speed and voltage limiting module is connected between the alternator and the spark ignition. The engine speed and voltage limiting module senses the voltage on the electrical bus and closes a kill switch to prevent spark ignition if the sensed voltage exceeds a specified threshold.

### BRIEF DESCRIPTION OF THE DRAWINGS

FIG. 1 is a perspective view of a walk behind greensmower with an engine speed and voltage limiter for a generator supplying power to an electric reel drive motor according to a first embodiment of the invention.

FIG. 2 is a schematic diagram of an engine speed and voltage limiter for a generator supplying power to an electric reel drive motor according to a first embodiment of the invention.

### DESCRIPTION OF THE PREFERRED EMBODIMENT

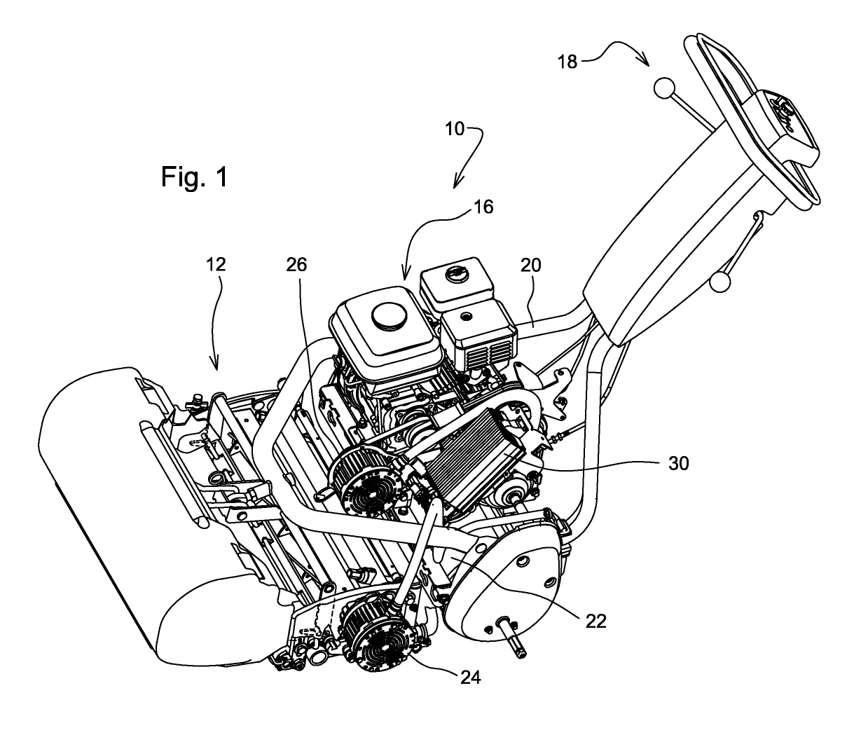

In FIG. 1, walk behind greensmower 10 is a grass mowing machine having reel mower cutting unit 12. The reel mower cutting unit includes spiral cutting blades that rotate on a horizontal axis in close proximity to a bedknife. The walk behind greensmower may have an internal combustion engine 16 and handle assembly mounted to frame 20. The frame may be supported, at least in part, by traction drum 22 operably coupled to the engine and rotated to move the machine forward during mowing operations. The drive system may include one or more pulleys and/or gears between the engine and traction drum.

A preferred embodiment of the engine speed and voltage limiter is shown on a walk behind greensmower, but the present invention also may be provided on other grass mowing machines such as riding greensmowers, fairway mowers, or other grass mowing machines having one or more reel mower cutting units.

The reel mower cutting unit may be rotated by electric reel drive motor 24. The electric motor may be mounted to a side panel on the left or right sides of the cutting unit. The electric reel drive motor may be bidirectional and variable speed, meaning that it can spin forward or reverse and at a range of rotational speeds. The electric reel drive motor may be powered directly by engine driven alternator 26 connected to an electrical bus.

For example, the engine driven alternator may be a 48-V, 180 amp alternator that is belt-driven by the internal combustion engine. The alternator may be designed to supply constant power to an electrical bus for the cutting reel circuit at a specified engine speed. However, the bus voltage may be unregulated, and engine speed may not be limited if the governor is overridden or abnormal fuel/air conditions are encountered. If that occurs, output voltage of the generator or alternator to the voltage bus may exceed the upper voltage limit of a motor controller.

The grass mowing machine also may include other circuits, including starter, safety interlocks, lights, and accessory circuits, that are separately powered by a 12-V battery.

In one embodiment, electric reel drive motor 24 may be connected to and controlled by electronic motor controller 30. The controller may be connected to the electrical bus to regulate power to the motor. The controller may be configured to run the motor at a consistent reel rotational speed across a wide throttle range, to maintain a desired cut quality, or may vary the speed in response to operator commands or other inputs.

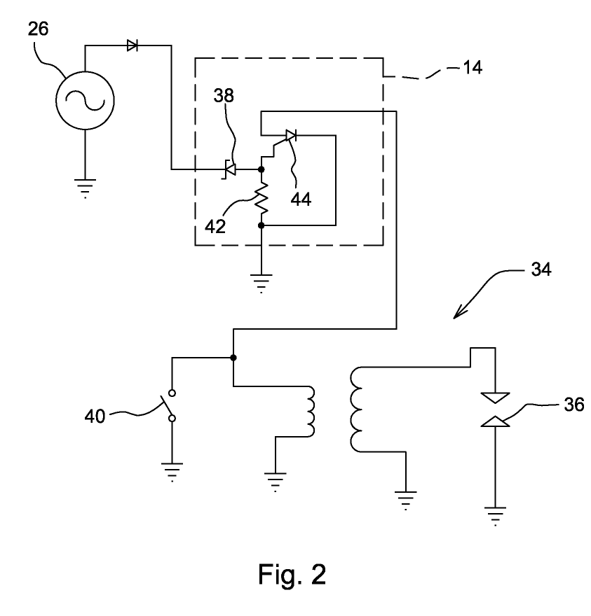

In an embodiment shown in FIG. 2, engine speed and voltage limiter 14 may be a module connected between alternator 26 and ignition 34. The engine speed and voltage limiting module may be included and/or packaged together with electronic motor controller 30. The engine speed and voltage limiter senses the output voltage of the alternator on the electrical bus. If the voltage sensed on the electrical bus exceeds a predetermined threshold, the engine speed and voltage limiter interrupts the ignition function of the internal combustion engine. The engine speed and voltage limiter may reduce firing pulses to spark plug 36 so that it is impossible to accelerate past the engine speed limit, thereby limiting the output voltage of the alternator or generator.

In one embodiment, the engine speed and voltage limiter module includes zener diode 38 connected to the alternator output. The zener diode may permit current in a reverse direction only if the voltage exceeds a threshold value exceeding the desired or normal bus voltage of 48 volts. For example, the threshold may be 68 volts. If the voltage exceeds the threshold, current flows through the zener diode and triggers solid state switch 44, which reduces firing pulses to the spark plug by bypassing the current flow through the ignition primary. Solid state switch 44 may be a silicon controlled rectifier (SCR) 44 between the zener diode and kill switch 40. Resistor 42 also may be included in the engine speed and voltage limiter module between the zener diode and engine ground.

In one embodiment, kill switch 40 may be connected between the engine speed and voltage limiter module 14 and ground. The grass mowing machine also may use the kill switch for one or more other safety interlocks to stop firing pulses to the spark plug.

Having described a preferred embodiment, it will become apparent that various modifications can be made without departing from the scope of the invention as defined in the accompanying claims.

1. A grass mowing machine comprising:
an electric motor rotating a cutting reel at a specified reel speed;
an electric generator driven by an internal combustion engine and providing a voltage on an electrical bus to the electric motor; the internal combustion engine having a spark ignition; and
an engine speed and voltage limiting module sensing the voltage on the electrical bus and interrupting the spark ignition if the voltage exceeds a specified threshold.

2. The grass mowing machine of claim 1 wherein the engine speed and voltage limiting module includes a zener diode.

3. The grass mowing machine of claim 1 wherein the engine speed and voltage limiting module includes a solid state switch.

4. The grass mowing machine of claim 1 further comprising a kill switch between the engine speed and voltage limiting module and ground.

5. The grass mowing machine of claim 1 further comprising an electronic motor controller connected to the electrical bus and providing commands to run the motor at a specified constant speed.

6. The grass mowing machine of claim 1 wherein the grass mowing machine is a walk behind greensmower.

7. A grass mowing machine comprising:
a reel mower cutting unit having spiral cutting blades rotating on a horizontal axis in close proximity to a bedknife;
an internal combustion engine mounted to a frame supported by a traction drum coupled to the engine and rotating to move the machine forward during mowing; the engine having a spark ignition;
an electric reel drive motor mounted to a side panel of the reel mower cutting unit and powered directly by an engine driven alternator supplying power to an electrical bus to which the electric reel drive motor is connected; and
an engine speed and voltage limiting module connected between the alternator and the spark ignition; the engine speed and voltage limiting module sensing the voltage on the electrical bus and closing a kill switch to prevent spark ignition if the sensed voltage exceeds a specified threshold.

8. The grass mowing machine of claim 7 further comprising an electronic controller connected to the electric reel drive motor and configured to operate the electric reel drive motor at a constant rotational speed.

9. The grass mowing machine of claim 7 wherein the alternator is driven by an endless belt.

10. The grass mowing machine of claim 7 wherein the engine speed and voltage limiting module includes a zener diode connected to a solid state switch.

11. A grass mowing machine comprising:
an electric reel drive motor mounted to a cutting reel and connected to an electrical bus;
an engine driving an alternator to produce a voltage on the electrical bus; and
an engine speed and voltage limiter monitoring the voltage on the electrical bus and, if the voltage exceeds a specified threshold, closing a kill switch to interrupt an ignition function of the engine driving the alternator.

12. The grass mowing machine of claim 11 further comprising a motor controller on the electrical bus and connected to the electric reel drive motor to operate the motor at a constant rotational speed.

13. The grass mowing machine of claim 11 wherein the grass mowing machine is a walk behind greensmower having a ground engaging roller driven by the engine.
